(19) United States
(12) Patent Application Publication
(10) Pub. No.: US 2012/0202037 A1
(43) Pub. Date: Aug. 9, 2012

(54) Solution Derived Nanocomposite Precursor Solutions, Methods for Making Thin Films and Thin Films Made by Such Methods

(75) Inventor: Elmira Ryabova, Mountainview, CA (US)

(73) Assignee: ADVENIRA, INC., Mountainview, CA (US)

(21) Appl. No.: 13/365,066

(22) Filed: Feb. 2, 2012

Related U.S. Application Data
(60) Provisional application No. 61/438,862, filed on Feb. 2, 2011.

(51) Int. Cl. C09D 1/00; H01B 1/12; B05D 1/18; B05D 1/28; B05D 3/06; B05D 3/12

(52) U.S. Cl. 428/220; 427/558; 427/557; 427/542; 427/541; 106/14.15; 252/519.3

(57) ABSTRACT

Solution derived nanocomposite (SDN) precursor solutions are disclosed that comprise one or more metal precursors that are dissolved in a liquid comprising polar protic and polar aprotic solvents. The precursor solutions are characterized by the formation of a gel after a shear force is applied to the precursor solution or to a thin layer of precursor solution. Also disclosed are methods using such precursor solutions to make thin films, thin films made using the precursor solutions, thin films having a minimum surface area and devices containing thin films as disclosed herein.

This application claims priority to U.S. Provisional Application Ser. No. 61/438,862 filed Feb. 2, 2011 entitled Solution Derived Nanocomposite Precursor Solutions and Methods for Making Thin Films the entire disclosure of which is expressly incorporated herein by reference.

### TECHNICAL FIELD

Solution derived nanocomposite (SDN) precursor solutions are disclosed that comprise one or more, preferably two or more, metal precursors that are dissolved in a liquid comprising polar protic and polar aprotic solvents. The precursor solutions are characterized by the formation of a gel after a shear force is applied to the precursor solution or to a thin layer of precursor solution. Also disclosed are methods using such precursor solutions to make thin films, thin films made using the precursor solutions, thin films having a minimum surface area and devices containing thin films as disclosed herein.

### BACKGROUND OF THE INVENTION

Thin film coatings or layers of multilayer film stacks are found in many devices. For example, binary and ternary metal-nonmetal compounds, including but not limited to Y₂O₃, ZrO₂, YZO, HfO₂, YHO, Al₂O₃, AlO₂, ZnO, AZO, ITO, SiC, Si₃N₄, SixCyNz, SixOyNz, TiO₂, CdS, ZnS, Zn₂SnO₄, SiO₂, WO₃, CeO₃ and so on, have been deposited as thin film coatings or layers of multilayer film stacks for various purposes. Such thin films include transparent conductive oxide (TCO) electrodes, passivating films, back surface field (BSF) layers, diffusion barriers, up-converters, down-converters, selective emitter masks, ion storage layers such as found in lithium ion batteries or electrochromic devices, solid electrolytes, moisture barriers, abrasion resistance layers, thermal barriers, impedance correction layers, surface modification layers, dielectric thin films, reflective and antireflective layers and the like.

There are a number of known methods for depositing such thin films. These methods can be divided into two categories: vacuum techniques such as PVD, CVD, ALD and MBE and non-vacuum techniques such as electroplating, CBD and screen printing. All of these approaches are expensive and time consuming.

Sol-gel processes have been used to make thin films. Sol-gel thin films can be made using a sol-gel medium containing a colloidal suspension of particles or a sol-gel solution. Processes using sol-gel solutions generally involve applying a thin film of a sol-gel precursor solution that contains metal precursors such as metal salts in combination with metal alkoxides. In some applications, the thin film is annealed at temperatures from 200° C. to 900° C. See e.g. US 2004/0058066 and US 2007/0190361.

Hybrid sol-gel thin films have also been made. Such thin films contain inorganic and organic components and can be divided into two classes: (1) those that contain organic molecules, prepolymers or polymers embedded in an inorganic matrix and (2) those that contain inorganic and organic components that are connected by covalent bonds. Such hybrid sol-gels can be made by UV induced polymerization or as a product of the specific reaction. Additional curing, if necessary, is generally performed at between about 20° C. and 200° C.

Solution sol-gel processes generally involve dip, spin or spray coating and are therefore limited in the surface area of the substrate that can be coated with the thin film. Examples include optical lenses and biomedical devices such as implants and vascular stents. The maximum surface area that can be covered by such techniques is typically less than about 50 cm². General purpose roll coaters have not been used successfully because of the difficulties in forming and maintaining a dynamic wetting line using non-Newtonian fluids.

### SUMMARY OF THE INVENTION

In one embodiment an SDN precursor solution contains (1) one or more, preferably two or more, sol-gel metal precursors and/or sol-gel metalloid precursors, (2) a polar protic solvent and (3) a polar aprotic solvent. The amount of each component is such that the SDN precursor solution forms a gel after a shear force is applied to the precursor solution or a thin layer of precursor solution. In a preferred embodiment, the amount of polar aprotic solvent is about 1-25 vol % of the precursor solution.

The metal in the sol-gel metal precursors can be one or more of the transition metals, the lanthanides, the actinides, the alkaline earth metals and Group IIIA through Group VA metals or combinations thereof with another metal or metalloid.

The metalloid in the sol-gel metalloid precursors can be one or more of boron, silicon, germanium, arsenic, antimony, tellurium, bismuth and polonium or combinations thereof with another metalloid or metal.

The sol-gel metal precursors can be metallic compounds selected from organometallic compounds, metallic organic salts and metallic inorganic salts. The sol-gel metalloid precursors can be metalloid compounds selected from organometalloid compounds, metalloid organic salts and metalloid inorganic salts. When more than one metal or metalloid is used it is preferred that one be an organic compound such as an alkoxide and the other an organic or inorganic salt.

The polar protic solvent used in the precursor solution is preferably an organic acid or alcohol, more preferably a lower alkyl alcohol such as methanol and ethanol. Water may also be present in the solution.

The polar aprotic solvent can be a halogenated alkane, alkyl ether, alkyl ester, ketone, aldehyde, alkyl amide, alkyl amine, alkyl nitrile or alkyl sulfoxide. Preferred polar aprotic solvents include methyl amine, ethyl amine and dimethyl formamide.

In one embodiment, the metal and/or metalloid precursor is dissolved in the polar protic solvent. The polar aprotic solvent is then added while the solution is stirred under conditions that avoid non-laminar flow. Acid or base, which is used as a catalyst for polymerization of the metal and/or metalloid precursors, can be added before or after the addition of the polar aprotic solvent. Preferably, the acid or base is added drop wise in a one step process while stirring.

If too much polar aprotic solvent is added gelation can occur. Accordingly, the amount of polar aprotic solvent can be determined empirically for each application. The amount of polar aprotic solvent needs to be below the amount that causes gelation during mixing but be sufficient to cause gelation of the precursor solution after a shear force is applied to the precursor solution, e.g. during application to a surface, or when a shear force is applied to a thin film of the precursor solution that has been deposited on the surface of a substrate, e.g. by application of a doctor blade to the precursor solution thin film.

In another embodiment, processes are disclosed for making a solid thin film layer. The process includes applying precursor solution to one or more surfaces of a substrate where the precursor solution contains (1) one or more sol-gel metal precursors and/or sol-gel metalloid precursors, (2) a polar protic solvent and (3) a polar aprotic solvent. Preferably, the application of the precursor provides sufficient shear force to cause gelation of the precursor solution to form a gelled thin layer. Alternatively, a shear force can be applied to a thin film of precursor solution deposited on a substrate.

In further embodiments of the disclosed processes, the gelled thin layer is exposed to UV, visible and/or infrared radiation. The irradiation causes further chemical reaction of the sol-gel precursors to form the thin gel. It also results in the formation of a solid thin film.

In other embodiments, additional organic components are present in the precursor solution. Upon exposure of the gelled thin film to radiation, preferably UV radiation, such components are polymerized to form a hybrid (inorganic/organic) sol-gel thin film. Such hybrid sol-gel thin films are desirable as they are less likely to form cracks and other defects upon thin film formation.

In other embodiments, the irradiation causes the temperature of the gel and/or thin film to increase to a temperature that allows the formation of a desirable microstructure in the thin film.

The application of the precursor solution can be by dip coating and/or spin coating or by roll coating. Each of these methods can provide sufficient shear force to cause gelation of the precursor solution.

Thin films made by the disclosed processes and multilayer films comprising one or more of such thin films are also disclosed. In some embodiments, such thin films are characterized by the surface area which is coated using the disclosed sol-gel precursor solutions. In particular, the sol-gel precursor solutions are readily adaptable for roll coater applications which allow the production of thin films with an area of up to about 20-100 m².

Devices comprising the disclosed thin films or multilayer film stacks containing one or more of such thin films are also disclosed.

### BRIEF DESCRIPTION OF THE DRAWINGS

FIG. 1 shows the relationship of dynamic viscosity as a function of shear force for a typical sol-gel precursor solution.

### DETAILED DESCRIPTION

Most prior art solutions used to make sol-gel thin films contain sol-gel precursors, a primary solvent such as a lower alcohol (e.g. methanol or ethanol) and an acid or base catalyst. Additional components may also be present. When applied as a thin film such solutions form a gel after the passage of time (e.g. about 5 seconds to 500 seconds) and a thin film after additional drying. Gel formation can be facilitated by increasing the pH and/or density of the solution, by raising the ambient temperature or by exposing the thin film layer to radiation.

The “sol-gel precursor solutions” (sometimes referred to as “SDN precursor solutions” or “precursor solutions”) disclosed herein are different in that gelation is determined by the properties of the mixed solvent used to make the sol-gel precursor solution. Rather than use a single solvent, the solvent used is a mixture of (1) a polar protic solvent such as methanol or ethanol and (2) a polar aprotic solvent such as dimethyl formamide, methyl amine or ethanol amine. By controlling the relative amounts of the protic and aprotic polar solvents and the amount of sol-gel precursors in solution (and other components that may be present) gel formation in the precursor solution can be controlled so that it occurs shortly after application on the surface of a substrate as a thin wet solution. The means of application of the precursor solution causes a sufficient shear force to cause gel formation. Gel formation can occur at ambient temperatures without the application of heat or radiation.

The sol-gel metal and/or metalloid precursors in the solution are chosen so that the formation of sol-gel polymers is thermodynamically favored. Without being bound by theory, it is believed that the mixture of polar protic and polar aprotic solvents results in a mixed solvent having an altered polarity (as compared to single solvent systems) that effectively lowers the activation energy for polymer formation by the metal and/or metalloid precursors. If too much polar aprotic solvent is used, the sol-gel precursor solution becomes unstable and can form a gel during its mixing or prior to its application as a solution as a thin film solution. This is undesirable and can result in the clogging of the equipment used for applying the precursor solution. It may also interfere with the formation of a uniform thin layer of precursor solution on the surface of the substrate. The gel formed from such a non-uniform layer will also be non-uniform and will likely contain undesirable defects. If too little polar aprotic solvent is used, the applied precursor solution will not gel in a time efficient manner on the substrate surface.

Accordingly, the formulation of the sol-gel precursor compositions may require semi-empirically determining the relative amounts of the metal and/or metalloid precursors and the protic polar and aprotic polar solvents used. When performing such tests, it is preferred that an acid or base catalyst be present in the amount anticipated for the eventual use of the sol-gel precursor. The catalyst facilitates polymerization of the precursors in the presence of the mixed solvent. Such determinations take into account the amount of shear force to be applied during the application of the precursor solution. In general such shear forces are from about 1N to about 1000N more typically from about 1N to about 100N and usually about 1 N to about 10N for the average wet layer thickness. The thickness of such wet layer films can be from about 1 nm to about 1 mm, about 10 nm to about 100 microns, about 10 nm to about 1 micron; about 50 nm to about 1 micron; about 100 nm to about 100 microns and from about 1 micron to about 1 mm. Alternatively, for a particular precursor solution, the shear force needed for appropriate thin film gel formation can be determined and used during the application process.

The time for gel formation after application of the shear force to the sol-gel solution is preferably between about 1 second and 1000 seconds, about 1 second to 100 seconds, about 1 second to about 10 seconds, about 1 second to less than 5 seconds and about 1 second to about 4 seconds.

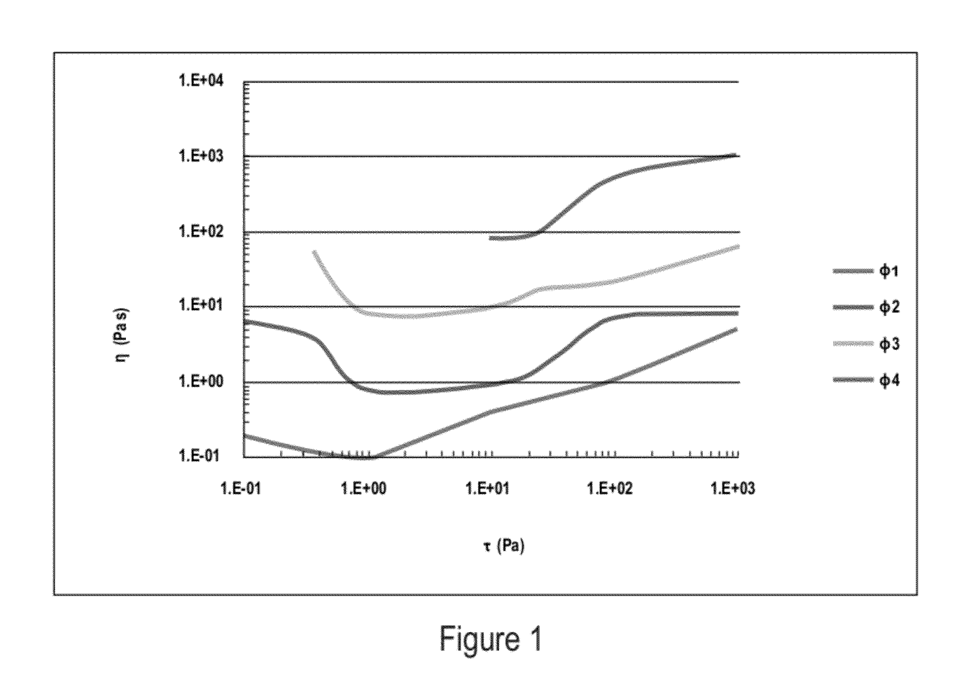

The SDN precursor solutions are typically Non-Newtonian dilatant solutions. As used herein, “dilatant” refers to a solution where the dynamic viscosity increases in a non linear manner as shear force is increased. The amount of shear force applied to the precursor solution and the dynamic viscosity for a typical precursor solution is set forth in FIG. 1. In FIG. 1, viscosity is defined as the ratio of shear stress to shear rate:

η=τ/γ(viscosity)

The shearing force τ acting over the unit area is known as the shear stress:

τ=F/A(shear stress)

The velocity gradient dv/dx through the layer is constant, where dv is the incremental change in velocity corresponding to a thickness, dx, of the liquid layer. This term is known as shear rate and is given by:

γ=dv/dx(shear rate)

In FIG. 1, φ1, φ2, φ3, φ4 are four different ratios for metal/metalloid compounds and solvents in ascending order for a precursor used to make an anti-reflective coating.

As used herein, the term “gelled thin film”, “thin film gel”, “sol-gel thin film” or grammatical equivalents means a thin film where the metal and/metalloid sol-gel precursors in a precursor solution form polymers which are sufficiently large and/or cross linked to form a gel. Such gels typically contain most or all of the original mixed solution and have a thickness of about 1 nm to about 10,000 nm, more preferably about 1 nm to about 50,000 nm, more preferably about 1 nm to about 5,000 nm and typically about 1 nm to about 500 nm.

Gelled thin films and the precursor solutions used to make them can also contain polymerizable moieties such as organic monomers, and cross-linkable oligomers or polymers. Examples include the base catalyzed reaction between melamine or resorcinol and formaldehyde followed by acidization and thermal treatment.

In some cases one or more of the metal and/or metalloid precursors can contain cross-linkable monomers that are covalently attached to the metal or metalloid typically via an organic linker. Examples include diorganodichlorosilanes which react with sodium or sodium-potassium alloys in organic solvents to yield a mixture of linear and cyclic organosilanes.

When cross-linkable moieties are used, it is preferred that the precursor solution also contain a polymerization initiator. Examples of photo-inducible initiators include titanocenes, benzophenones/amines, thioxanthones/amines, bezoinethers, acylphosphine oxides, benzilketals, acetophenones, and alkylphenones. Heat inducible initiators which are well known to those in the art can also be used.

As used herein, the term “thin film”, “sol-gel thin film” or grammatical equivalents means the thin film obtained after most or all of the solvent from a gelled thin film is removed. The solvent can be removed by simple evaporation at ambient temperature, evaporation by exposure to increased temperature of the application of UV, visible or IR radiation. Such conditions also favor continued polymerization of any unreacted or partially reacted metal and/or metalloid precursors. Preferably, 100 vol % of the solvent is removed although in some cases as much as 30 vol % can be retained in the thin gel. Single coat thin films typically have a thickness of between about 1 nm and about 10,000 nm, between about 1 nm and 1,000 nm and about 1 nm and 100 nm. When more than one coat of precursor composition is applied to form a thin film, the first layer can be allowed to gel and then converted to a thin film. A second coat of the same or a different precursor solution can then be applied and allowed to gel followed by its conversion to a thin film. In an alternate embodiment, the second coat of precursor composition can be applied to the gelled first layer. Thereafter the first and second gelled layers are converted to first and second thin films. Additional layers can be added in a manner similar to the above described approaches.

When one or more polymerization moieties are present, it is preferred that the thin file gel be exposed to an appropriate initiating condition to promote polymerization of the polymerizable moieties. For example, UV radiation can be used with the above identified photo-inducible initiators.

As used herein, a “hybrid thin film gel” or grammatical equivalents refers to a thin film gel that contains a polymerizable organic component.

As used herein, a “hybrid thin film” or grammatical equivalents refers to a thin film that contains an organic component that has been polymerized or partially polymerized.

The metal in said one or more sol-gel metal precursors is selected from the group consisting of transition metals, lanthanides, actinides, alkaline earth metals, and Group IIIA through Group VA metals. Particularly preferred metals include Al, Ti, Mo, Sn, Mn, Ni, Cr, Fe, Cu, Zn, Ga, Zr, Y, Cd, Li, Sm, Er, Hf, In, Ce, Ca and Mg.

The metalloid in said one or more sol-gel metalloid precursors is selected from boron, silicon, germanium, arsenic, antimony, tellurium, bismuth and polonium. Particularly preferred metalloids include B, Si, Ge, Sb, Te and Bi.

The sol-gel metal precursors are metal-containing compounds selected from the group consisting of organometallic compounds, metallic organic salts and metallic inorganic salts. The organometallic compound can be a metal alkoxide such as a methoxide, an ethoxide, a propoxide, a butoxide or a phenoxide.

The metallic organic salts can be, for example, formates, acetates or propionates.

The metallic inorganic salts can be halide salts, hydroxide salts, nitrate salts, phosphate salts and sulfate salts.

Metalloids can be similarly formulated.

### Solvents

Solvents can be broadly classified into two categories: polar and non-polar. Generally, the dielectric constant of the solvent provides a rough measure of a solvent's polarity. The strong polarity of water is indicated, at 20° C., by a dielectric constant of 80. Solvents with a dielectric constant of less than 15 are generally considered to be nonpolar. Technically, the dielectric constant measures the solvent's ability to reduce the field strength of the electric field surrounding a charged particle immersed in it. This reduction is then compared to the field strength of the charged particle in a vacuum. The dielectric constant of a solvent or mixed solvent as disclosed herein can be thought of as its ability to reduce the solute's internal charge. This is the theoretical basis for the reduction in activation energy discussed above.

Solvents with a dielectric constant greater than 15 can be further divided into protic and aprotic. Protic solvents solvate anions strongly via hydrogen bonding. Water is a protic solvent. Aprotic solvents such as acetone or dichloromethane tend to have large dipole moments (separation of partial positive and partial negative charges within the same molecule) and solvate positively charged species via their negative dipole.

### Polar Protic Solvents

Examples of the dielectric constant and dipole moment for some polar protic solvents are presented in Table 1.

TABLE 1
Polar protic solvents

| | Chemical | Boiling | Dielectric | | Dipole |
|---|---|---|---|---|---|
| Solvent | formula | point | constant | Density | moment |
| Formic acid | H—C(═O)OH | 101° C. | 58 | 1.21 g/ml | 1.41 D |
| n-Butanol | CH₃—CH₂—CH₂—CH₂—OH | 118° C. | 18 | 0.810 g/ml | 1.63 D |
| Isopropanol (IPA) | CH₃—CH(—OH)—CH₃ | 82° C. | 18 | 0.785 g/ml | 1.66 D |
| n-Propanol | CH₃—CH₂—CH₂—OH | 97° C. | 20 | 0.803 g/ml | 1.68 D |
| Ethanol | CH₃—CH₂—OH | 79° C. | 30 | 0.789 g/ml | 1.69 D |
| Methanol | CH₃—OH | 65° C. | 33 | 0.791 g/ml | 1.70 D |
| Acetic acid | CH₃—C(═O)OH | 118° C. | 6.2 | 1.049 g/ml | 1.74 D |
| Water | H—O—H | 100° C. | 80 | 1.000 g/ml | 1.85 D |

Preferred polar protic solvents have a dielectric constant between about 20 and 40. Preferred polar protic solvents have a dipole moment between about 1 and 3.

Polar protic solvents are generally selected from the group consisting of organic acids and organic alcohols. When an organic acid is used as a polar protic solvent, it is preferred that it be formic acid, acetic acid, propionic acid or butyric acid, most preferably acetic and/or propionic acids.

When an organic alcohol is used as a polar protic solvent it is preferred that it be a lower alkyl alcohol such as methyl alcohol, ethyl alcohol, propyl alcohol or butyl alcohol. Methanol and ethanol are preferred.

### Polar Aprotic Solvents

Examples of the dielectric constant and dipole moment for some polar aprotic solvents are set forth in Table 2.

TABLE 2
Polar aprotic Solvents

| | | Boiling point | | | |
|---|---|---|---|---|---|
| | Chemical | http://en.wikipedia.org/wiki/Solvent- | Dielectric | | Dipole |
| Solvent | formula | cite note-boil-6#cite note-boil-6 | constant | Density | moment |
| Dichloromethane | CH₂Cl₂ | 40° C. | 9.1 | 1.3266 g/ml | 1.60 D |
| (DCM) | | | | | |
| Tetrahydrofuran | /—CH₂—CH₂—O—CH₂—CH₂—\ | 66° C. | 7.5 | 0.886 g/ml | 1.75 D |
| (THF) | | | | | |
| Ethyl acetate | CH₃—C(═O)—O—CH₂—CH₃ | 77° C. | 6.02 | 0.894 g/ml | 1.78 D |
| Acetone | CH₃—C(═O)—CH₃ | 56° C. | 21 | 0.786 g/ml | 2.88 D |
| Dimethylformamide | H—C(═O)N(CH₃)₂ | 153° C. | 38 | 0.944 g/ml | 3.82 D |
| (DMF) | | | | | |
| Acetonitrile (MeCN) | CH₃—C≡N | 82° C. | 37.5 | 0.786 g/ml | 3.92 D |
| Dimethyl sulfoxide | CH₃—S(═O)—CH₃ | 189° C. | 46.7 | 1.092 g/ml | 3.96 D |
| (DMSO) | | | | | |

Preferred polar aprotic solvents have a dielectric constant between about 5 and 50. Preferred polar aprotic solvents have a dipole moment between about 2 and 4.

The polar aprotic solvent can be selected from the group consisting of asymmetrical halogenated alkanes, alkyl ether, alkyl esters, ketones, aldehydes, alkyl amides, alkyl amines, alkyl nitriles and alkyl sulfoxides.

Asymmetrical halogenated alkanes can be selected from the group consisting of dichloromethane, 1,2-dichloroethane, 1,2-dichloropropane, 1,3-dichloropropane, 2,2-dichloropropane, dibromomethane, diiodomethane, bromoethane and the like.

Alkyl ether polar aprotic solvents include tetrahydrofuran, methyl cyanide and acetonitrile.

Ketone polar aprotic solvents include acetone, methyl isobutyl ketone, ethyl methyl ketone, and the like.

Alkyl amide polar aprotic solvents include dimethyl formamide, dimethyl phenylpropionamide, dimethyl chlorobenzamide and dimethyl bromobenzamide and the like.

Alkyl amine polar aprotic solvents include diethylenetriamine, ethylenediamine, hexamethylenetetramine, dimethylethylenediamine, hexamethylenediamine, tris(2-aminoethyl)amine, ethanolamine, propanolamine, ethyl amine, methyl amine, and (1-2-aminoethyl)piperazine.

A preferred alkyl nitrile aprotic solvent is acetonitrile.

A preferred alkyl sulfoxide polar aprotic solvent is dimethyl sulfoxide. Others include diethyl sulfoxide and butyl sulfoxide.

Another preferred aprotic polar solvent is hexamethylphosphoramide.

### Precursor Solutions

The total amount of metal and/or metalloid precursors in the precursor solution is generally about 5 vol % to 40 vol % when the precursors are a liquid. However, the amount may be from about 5 vol % to about 25 vol % and preferably from about 5 vol % to 15 vol %.

The polar protic solvent makes up most of the mixed solvent in the precursor solution. It is present as measured for the entire volume of the precursor solution at from about 50 vol % to about 90 vol %, more preferably about 50 to about 80 vol % and most preferably about 50-70 vol %.

The polar aprotic solvent in the precursor solution is about 1-25 vol % of the solution, more preferably about 1-15 vol % and most preferably about 1-5 vol %.

The application of the precursor solution can be by dip coating, spin coating or a combination of both. Alternatively, the application can be by roll coating or roll to roll coating when flexible substrates are used.

The use of the disclosed precursor solutions allows for the coating of the surfaces of three dimensional structures using dip coating to form a thin film enveloping the structure. This approach can be supplemented by spinning the coated three dimensional structure

Alternatively, a predetermined surface of a structure can be coated with the precursor solution using spin coating or roll coating. In some embodiments, multiple surfaces can be coated by using multiple roll coaters.

When a flat surface is coated, roll coating is the preferred method to apply the precursor solution. Roll coaters can also be used in roll to roll coating of flexible substrates. In either case, the coated surface has an area of at least 50 cm², at least 100 cm², at least 1,000 cm², at least 5,000 cm², at least 10,000 cm², at least 15,000 cm², at least 20,000 cm² and most preferably at least 25,000 cm². The upper limit of one dimension of the area coated is to the length of the roll in the roll coater. The length of a roll can be from about 5 or 10 centimeters to about 4 or 5 meters. Accordingly, one dimension of the thin film can also have a length within these ranges. The other dimension is limited by the length of the substrate which can be translated through the roll coater. In a roll to roll application, the second dimension is limited to the length of the flexible substrate. Accordingly, the use of sol-gel precursor solutions in roll coater applications allow the production of thin films with an area of up to about 20 m², 100 m²,500 m² and as much as 1,000 m² or more. Thus the area of the thin film can range from 50 cm² to 1,000 m².

If a single coat of precursor solution is applied, it is preferred that the thin film formed be from about 1 nm to about 500 nm thick, more preferably about 1 nm to about 250 nm think and most preferably about 1 nm to about 100 nm thick.

Other characteristics of the thin films formed useing sol-gel precursors relate to the internal stress in the thin layer and the defect concentration in the thin film. Whereas prior art thin films, such as those made by sputtering, have internal stresses in the range of GPa, thin films as disclosed herein have internal stresses in the range of KPa, e.g. 1000 Pa to less than about 1,000,000 Pa, However, the internal stress in the thin film may be in the MPa range as well. As for defect concentration, prior art thin films, such as those made by sputtering, have defect concentrations between 1.5-2%. Thin films made according to the disclosure herein typically have a defect concentration less than 0.001%, but may be as high as 0.01%, 0.1% or 1.0%. The range of defect concentration is therefore 0.001% or less to about 1.0%.

Preferred precursor solutions are as follows:

Embodiment (1): The preferred precursor solution comprises one or more, preferably two or more, sol-gel metal precursors and/or sol-gel metalloid precursors, one or more polar protic solvents and one or more polar aprotic solvent, wherein the precursor solution forms a gel after a shear force is applied to said precursor solution.

Embodiment (2): The above preferred precursor solution wherein the viscosity of the solution increases with increasing shear force.

Embodiment (3): The above preferred precursor solution wherein the metal in the one or more sol-gel metal precursors is selected from the group consisting of transition metals, lanthanides, actinides, alkaline earth metals, and Group IIIA through Group VA metals, any subset of the group or any combination of members of the group or subset of the group.

Embodiment (4) The above preferred precursor solution wherein the metalloid in the one or more sol-gel metalloid precursors is selected from the group consisting of boron, silicon, germanium, arsenic, antimony, tellurium, bismuth and polonium, any subset of the group or any combination of members of the group or subset of the group.

Embodiment (5): The above preferred precursor solution wherein the one or more sol-gel metal precursors are metallic compounds selected from the group consisting of organometallic compounds, metallic organic salts and metallic inorganic salts, any subset of the group or any combination of members of the group or subset of the group.

When one or more organometallic compounds are used, the preferred organmetallic compound is a metal alkoxide. In such cases the metal alkoxide is preferably selected from the group consisting of methoxides, ethoxides, propoxides, butoxides and phenoxides, any subset of the group or any combination of members of the group or subset of the group.

When metallic organic salts are used, the preferred precursor solution comprises a metallic organic salt preferably selected from the group consisting of formates, acetates and propionates, any subset of the group or any combination of members of the group or subset of the group.

When one or more metal inorganic salts are used, the metallic inorganic salt is preferably selected from the group consisting of halide, hydroxide, nitrate, phosphate and sulfate, any subset of the group or any combination of members of the group or subset of the group.

Embodiment (6): The above preferred precursor solution wherein the one or more polar protic solvents are selected from the group consisting of organic acids and organic alcohols.

When one or more organic acids are used, the organic acid is preferably selected from the group consisting of formic acid, acetic acid, propionic acid and butyric acid, any subset of the group or any combination of members of the group or subset of the group.

When one or more organic alcohols are used, the organic alcohol is preferably selected from the group consisting of methyl alcohol, ethyl alcohol, propyl alcohol and butyl alcohol, any subset of the group or any combination of members of the group or subset of the group

Embodiment (7): The above preferred precursor solution wherein the one or more polar aprotic solvents are preferably selected from the group consisting of halogenated alkyl, alkyl ether, alkyl esters, ketones, aldehydes, alkyl amides, alkyl amines, alkyl nitriles and alkyl sulfoxides, any subset of the group or any combination of members of the group or subset of the group. When one or more halogenated alkyl polar aprotic solvent is used, the halogenated alkyl polar aprotic solvent is preferably selected from the group consisting of dichloromethane, 1,2-dichloroethane, 1,2-dichloropropane, 1,3-dichloropropane, 2,2-dichloropropane, dibromomethane, diiodomethane and bromoethane, any subset of the group or any combination of members of the group or subset of the group.

When one or more alkyl ether polar aprotic solvents are used, the alkyl ether polar aprotic solvent is preferably selected from the group consisting of tetrahydrofuran, methyl cyanide and acetonitrile, any subset of the group or any combination of members of the group or subset of the group.

When one or more ketone polar aprotic solvents are used, the ketone polar aprotic solvent is preferably selected from the group consisting of acetone, methyl isobutyl ketone and ethyl methyl ketone, any subset of the group or any combination of members of the group or subset of the group.

When one or more alkyl amide polar aprotic solvents are used, the alkyl amide polar aprotic solvent is preferably selected from the group consisting of dimethyl formamide, dimethyl phenylpropionamide, dimethyl chlorobenzamide and dimethyl bromobenzamide, any subset of the group or any combination of members of the group or subset of the group.

When one or more alkyl amine polar aprotic solvents are used, the alkyl amine polar aprotic solvent is preferably selected from the group consisting of diethylenetriamine, ethylenediamine, hexamethylenetetramine, dimethylethylenediamine, hexamethylenediamine, tris(2-aminoethyl)amine, ethanolamine, propanolamine, ethyl amine, methyl amine, (1-2-aminoethyl)piperazine, any subset of the group or any combination of members of the group or subset of the group.

When one or more alkyl nitrile aprotic solvents are used, it is preferred that at least one comprises acetonitrile.

When one or more alkyl sulfoxide aprotic solvents are used, the alkyl sulfoxide aprotic solvent is preferably selected from the group consisting of dimethyl sulfoxide, diethyl sulfoxide and butyl sulfoxide, any subset of the group or any combination of members of the group or subset of the group.

Embodiment (8): The above preferred precursor solution wherein at least one of the metal or metalloid precursors is an organometallic or organometalloid compound comprising a polymerizable organic moiety.

Embodiment (9): The above preferred precursor solution further comprising a polymerizable organic monomer, organic oligomer or organic polymer.

Embodiment (10): The precursor solution of any of the preceding embodiments further comprising a photo-inducible polymerization catalyst. The photo-inducible polymerization catalyst is preferably selected from the group consisting of titanocenes, benzophenones/amines, thioxanthones/amines, bezoinethers, acylphosphine oxides, benzilketals, acetophenones, and alkylphenones, any subset of the group or any combination of members of the group or subset of the group.

Embodiment (11): The precursor solution of any of the preceding embodiments further comprising an acid or base catalyst.

### Process for Making Thin Films

A process for making a solid thin film layer comprises the step of applying the precursor solution disclosed herein, including the above specific embodiments, to one or more surfaces of a substrate wherein the applying provides sufficient shear force to cause gelation of the precursor solution to form a gelled thin layer.

The process can further comprise exposing said gelled thin layer to UV, visible or infrared radiation. In such embodiments The radiation preferably causes formation of a solid thin film. This can occur due to an increase in the temperature of gelled thin layer so as to form a crystalline structure.

The application of the precursor solution can be by dip coating, spin coating or a combination of both. Roll coating or roll to roll coating can also be used.

### Thin Films and Devices Containing Thin Films

Examples of thin films made according to the disclosure herein or as characterized herein include but are not limited to transparent conductive oxide (TCO) electrodes, passivating films, back surface field (BSF) layers, diffusion barriers up-converters, down-converters, selective emitter masks, ion storage layers such as found in lithium ion batteries or electrochromic devices, solid electrolytes, moisture barriers, abrasion resistance layers, thermal barriers, impedance correction layers, surface modification layers, dielectric thin films, reflective and antireflective layers and the like.

The devices which can contain the thin film include but are not limited to solar cells, especially large area solar cells, electrochromic glass, low emission glass and ultra thin glass.

Where a range of values is provided above relating to the disclosed and claimed subject matter, it is to be understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

### Example 1

A corrosion and moisture thin film barrier can be made of Al₂O₃. A precursor solution was made as follows. Briefly 129 mg of AlCl₃ (H₂O)₆ and 20 mg of AlNO₃ (H₂O)₃ were dissolved in 1.1 liter of ethanol in a Teflon™ lined container that was magnetically stirred to maintain laminar flow. Two ml of Y doped SiO₂ in 40 ml of 2% nitric acid was added. 0.8 ml of methyl amine in methanol was slowly added to prevent gel formation. The resulting precursor solution was applied onto anodized substrates using dip coating as a corrosion protective layer and onto plastic film as a moisture barrier layer using spin coating to produce a wet layer approximately 130 nm thick. The gel formed within 90 seconds and thereafter was treated IR radiation to form a thin film having a thickness of about 40 nm. The resulting increase in effective dielectric thickness as measured by the Eddy current method was equivalent to 7 microns.

### Example 2

Al/Zn oxide forms a transparent conductive oxide thin film. A precursor solution was made by combining 280 ml of Zn acetate (H₂O)₂ and 2.2 ml of aluminum nitrate (H₂O)₉ in 2.5 liters of ethanol and mixed as described in Example 1. 1.4 ml of ethyl amine in ethanol was added slowly to prevent gel formation. The resulting precursor solution was applied to the surface of glass using spin coating to form a wet layer about 80 nm thick. The gel was then exposed to IR radiation to form a thin film that was about 25 nm thick. Film stacks combined of 6-8 layers of AZO demonstrated >88% T (350-850 nm) and 5-10 Ohm·cm resistivity.

What is claimed is:

1. A precursor solution comprising one or more sol-gel metal precursors and/or sol-gel metalloid precursors, a polar protic solvent and a polar aprotic solvent, wherein said precursor solution forms a gel after a shear force is applied to said precursor solution and said polar aprotic solvent is present in said solution at between about 1 and 25 vol %.

2. The precursor solution of claim 1 wherein the viscosity of said solution increases with increasing shear force.

3. The precursor solution of claim 1 wherein the metal in said one or more sol-gel metal precursors is selected from the group consisting of transition metals, lanthanides, actinides, alkaline earth metals, and Group IIIA through Group VA metals.

4. The precursor solution of claim 1 wherein the metalloid in said one or more sol-gel metalloid precursors is selected from the group consisting of boron, silicon, germanium, arsenic, antimony, tellurium, bismuth and polonium.

5. The precursor solution of claim 1 wherein said one or more sol-gel metal precursors are metallic compounds selected from the group consisting of organometallic compounds, metallic organic salts and metallic inorganic salts.

6. The precursor solution of claim 5 wherein said organometallic compound is a metal alkoxide.

7. The precursor solution of claim 6 wherein said metal alkoxide is selected from the group consisting of methoxides, ethoxides, propoxides butoxides and phenoxides.

8. The precursor solution of claim 5 wherein said metallic organic salt is selected from the group consisting of formates, acetates and propionates.

9. The precursor solution of claim 5 wherein said metallic inorganic salt is selected from the group consisting of halide, hydroxide, nitrate, phosphate and sulfate.

10. The precursor solution of claim 1 wherein said polar protic solvent is selected from the group consisting of organic acids and organic alcohols.

11. The precursor solution of claim 10 wherein said organic acid is selected from the group consisting of formic acid, acetic acid, propionic acid and butyric acid.

12. The precursor solution of claim 10 wherein said organic alcohol is selected from the group consisting of methyl alcohol, ethyl alcohol, propyl alcohol and butyl alcohol.

13. The precursor solution of claim 1 wherein said polar aprotic solvent is selected from the group consisting of halogenated alkyl, alkyl ether, alkyl esters, ketones, aldehydes, alkyl amides, alkyl amines, alkyl nitriles and alkyl sulfoxides.

14. The precursor solution of claim 1 wherein said halogenated alkyl polar aprotic solvent is selected from the group consisting of dichloromethane, 1,2-dichloroethane, 1,2-dichloropropane, 1,3-dichloropropane, 2,2-dichloropropane, dibromomethane, diiodomethane and bromoethane.

15. The precursor solution of claim 13 wherein said alkyl ether polar aprotic solvent is selected from the group consisting of tetrahydrofuran, methyl cyanide and acetonitrile.

16. The precursor solution of claim 13 wherein said ketone polar aprotic solvent is selected from the group consisting of acetone, methyl isobutyl ketone and ethyl methyl ketone.

17. The precursor solution of claim 13 wherein said alkyl amide polar aprotic solvent is selected from the group consisting of dimethyl formamide, dimethyl phenylpropionamide, dimethyl chlorobenzamide and dimethyl bromobenzamide.

18. The precursor solution of claim 13 wherein said alkyl amine polar aprotic solvent is selected from the group consisting of diethylenetriamine, ethylenediamine, hexamethylenetetramine, dimethylethylenediamine, hexamethylenediamine, tris(2-aminoethyl)amine, ethanolamine, propanolamine, ethyl amine, methyl amine, (1-2-aminoethyl)piperazine.

19. The precursor solution of claim 13 wherein said alkyl nitrile aprotic solvent comprises acetonitrile.

20. The precursor solution of claim 13 wherein said alkyl sulfoxide aprotic solvent is selected from the group consisting of dimethyl sulfoxide, diethyl sulfoxide and butyl sulfoxide.

21. The precursor solution of claim 1 wherein at least one of said metal or metalloid precursors is an organometallic or organometalloid compound comprising a polymerizable organic moiety.

22. The precursor solution of claim 1 further comprising polymerizable organic monomer, organic oligomer or organic polymer.

23. The precursor solution of any of claim 1 further comprising a photo-inducible polymerization catalyst.

24. The precursor solution of claim 23 wherein said photo-inducible polymerization catalyst is selected from the group consisting of titanocenes, benzophenones/amines, thioxanthones/amines, bezoinethers, acylphosphine oxides, benzilketals, acetophenones, and alkylphenones.

25. The precursor solution of claim 1 further comprising an acid or base catalyst.

26. A process for making a solid thin film layer comprising the step of applying the precursor solution of claim 1 to one or more surfaces of a substrate wherein said applying provides sufficient shear force to cause gelation of said precursor solution to form a gelled thin layer.

27. The process of claim 26 further comprising exposing said gelled thin layer to UV, visible or infrared radiation.

28. The process of claim 27 wherein said exposing causes formation of a solid thin film.

29. The process of claim 28 wherein said exposing raises the temperature of said solid thin film so as to form a crystalline structure.

30. The process of claim 26 wherein said applying is by dip coating, spin coating or a combination of both.

31. The process of claim 26 wherein said applying is by roll coating or roll to roll coating.

32. A thin film made according to the process of claim 26.

33. A thin film having a thickness from 1 to 500 nanometers and a surface area of at least 50 cm².

34. A device comprising a thin film having a thickness from 1 to 500 nanometers and having a surface area of at least 50 cm².
